(19) United States
(12) Patent Application Publication
(10) Pub. No.: US 2005/0022202 A1
(43) Pub. Date: Jan. 27, 2005

(54) Request failover mechanism for a load balancing system

(75) Inventors: Harichandra Reddy Sannapa Reddy, Bangalore (IN); Balaji Koutharapu, Bangalore (IN); Sridhard Satuloori, Bangalore (IN)

Correspondence Address: Robert C. Kower;Meyertons, Hood, Kivlin, Kowert & Goetzel, P.C., P.O. Box 398, Austin, TX, 78767, US

(73) Assignee: Sun Microsystems, Inc., Santa Clara, CA (US)

(21) Appl. No.: 10/616,444

(22) Filed: Jul. 9, 2003

(51) Int. Cl. G06F 9/46

(52) U.S. Cl. 718/105; 718/100

(57) ABSTRACT

A system and method for a request failover mechanism on a load balancing system. The method may include a load balancer selecting a node from among a plurality of nodes associated with the load balancer to handle a request. The load balancer may limit selection to those nodes not known by the load balancer to be inactive. The load balancer may then determine if the selected node is able to service the request. In response to determining the selected node is unable to handle the request, the load balancer may select another node from among the plurality of nodes not known by the load balancer to be inactive. In various embodiments, the load balancer may mark nodes which are unable to service requests as inactive. The load balancer may determine if nodes are able to service requests by various methods, including active probing, passive probing, and dummy probing.

### BACKGROUND OF THE INVENTION

1. Field of the Invention

This invention relates to the field of network computer systems and, more particularly, to a system and method for request failover on a load balancing system.

2. Description of the Related Art

As workloads on modern computer systems become larger and more varied, more and more computational resources are needed. For example, a request from a client to web site may involve a load balancer, a web server, a database, and an application server. Alternatively, some large-scale scientific computations may require multiple computational nodes operating in synchronization as a kind of parallel computer.

Any such collection of computational resources and/or data tied together by a data network may be referred to as a distributed system. A distributed system may be a set of identical nodes at a single location connected together by a local area network. Alternatively, the nodes may be geographically scattered and connected by the Internet, or a heterogeneous mix of computers, each acting as a different resource. Each node may have a distinct operating system and be running a different set of applications.

Nodes in a distributed system may also be arranged as clusters of nodes, with each cluster working as a single computer system to handle requests. Alternatively, clusters of nodes in a distributed system may act semi-independently in handling a plurality of workload requests. In such an implementation, each cluster may have one or more shared data sources accessible to all nodes in the cluster.

Workload may be assigned to distributed system components via a load balancer, which relays requests to individual nodes or clusters. Depending on the number of requests and the number of clusters and nodes within a distributed system, a load balancer may be a software agent running on one of the nodes, a dedicated load-balancing node separate from the rest of the nodes in the system, or a hierarchy of load balancers.

In the case of a load-balancing hierarchy, each load-balancing node may be responsible for sending work requests to a lower tier of the hierarchy, until a single load balancing node is responsible for sharing a fraction of the overall requests between a small, manageable cluster of bottom-level servers which may service the request.

For efficiency purposes, many load balancing nodes may have minimal interaction with requests and lower levels in the hierarchy, aside from determining which lower-level node should handle a request and forwarding the request to that node. Once a request is forwarded to a lower-level node, the load balancing node may cease to track the status of the request. Furthermore, each load balancing node may be unable to determine the functional status of lower-level nodes in the hierarchy.

This situation may be problematic if a lower-level node undergoes a failure. For example, requests sent to a non-functional node may not be serviced, which in turn may lead to a timeout failure. With no way to track if a lower-level node is functional, a higher-level node may continue forwarding requests to non-functional lower-level nodes. If one or more nodes remain non-functional for an extended period of time, then a significant number of requests may go unanswered. Moreover, if a higher-level tier is unaware of a node failure in a lower-level tier, it may be some time before the failure is discovered and repaired. Even if a load balancing node was aware that all of its lower-level nodes were non-functional, it has no way to prevent its higher level load balancer from continuing to send it requests.

### SUMMARY

A system and method for a request failover mechanism on a load balancing system is disclosed. The method may include a load balancer selecting a node from among a plurality of nodes associated with the load balancer to handle a request. The load balancer may limit selection to those nodes not known by the load balancer to be inactive. The load balancer may then determine if the selected node is able to service the request. In response to determining the selected node is unable to handle the request, the load balancer may select another node from among the plurality of nodes not known by the load balancer to be inactive. In various embodiments, the load balancer may mark nodes which are unable to service requests as inactive. The load balancer may determine if nodes are able to service requests by various methods, including active probing, passive probing, and dummy probing.

### BRIEF DESCRIPTION OF THE DRAWINGS

FIG. 1 illustrates a block diagram of load balancer hierarchy, according to one embodiment.

FIG. 2 is a flow diagram illustrating one embodiment of a method for a request failover mechanism in a load-balancing system.

FIG. 3 is a flow diagram illustrating one example of a method for an active probing mechanism for determining the active/inactive status of downstream nodes.

FIG. 4 illustrates another embodiment for request failover using a passive probing mechanism.

FIG. 5 illustrates yet another example of a method for request failover, this time using a dummy messaging mechanism, according to one embodiment.

FIG. 6 illustrates an exemplary computer subsystem for implemented a load balancing node, according to one embodiment.

While the invention is susceptible to various modifications and alternative forms, specific embodiments are shown by way of example in the drawings and are herein described in detail. It should be understood, however, that drawings and detailed description thereto are not intended to limit the invention to the particular form disclosed, but on the contrary, the invention is to cover all modifications, equivalents and alternatives falling within the spirit and scope of the present invention as defined by the appended claims.

### DETAILED DESCRIPTION OF EMBODIMENTS

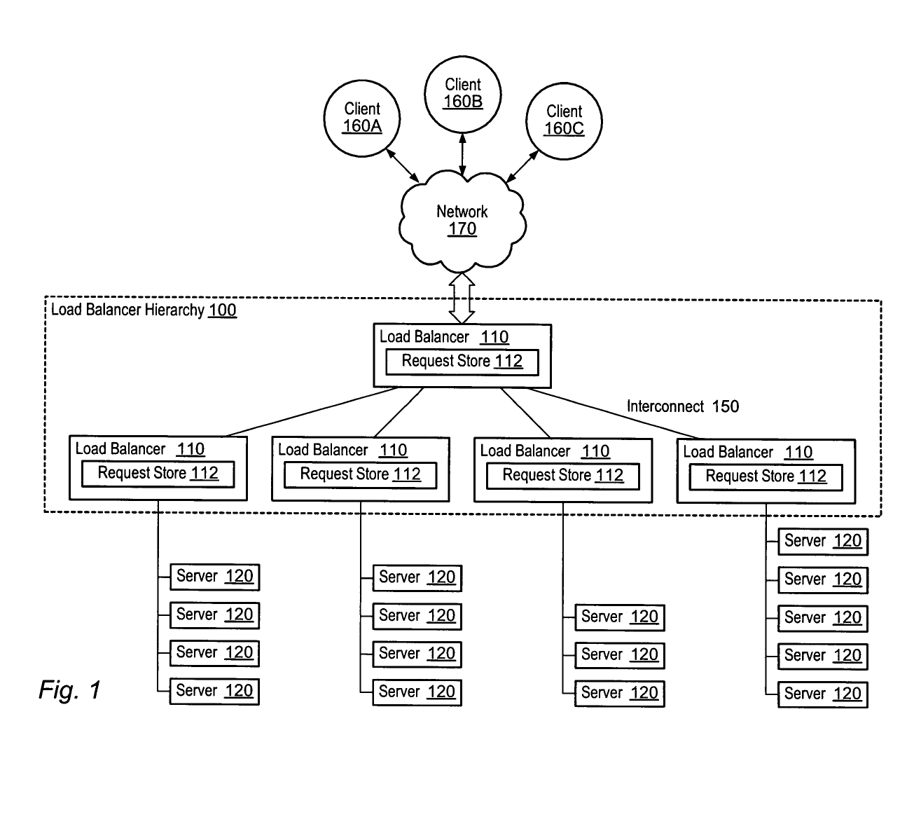

Turning now to FIG. 1, a block diagram of load balancer hierarchy 100 is shown. Load balancer hierarchy 100 is comprised of a plurality of load balancers 110 grouped into multiple levels. Load balancers 110 in load balancer hierarchy 100 are connected by interconnect 150. Likewise, each load balancer 110 at the bottom level of load balancer hierarchy 100 is connected to multiple servers 120 by interconnect 150. Load balancer hierarchy 100 is connected to clients 160A-C via network 170.

Load balancer hierarchy 100 is operable to receive requests from clients 160A -C. These requests may then be forward through the levels of the load balancer hierarchy 100 until they reach servers 120. Each load balancer 110 is operable to balance the forwarded load requests among lower-level load balancers 110 or servers 120 such that requests are distributed between lower levels in the load balancer hierarchy 100 according to a load balancing methodology. For example, requests may be load balanced according to the number of pending requests for each node, according to a round robin scheme, or any other load balancing scheme.

Each load balancer 110 may also include request store 112, which contains a list of all pending requests that have been routed through that particular load balancer 110. In various embodiments, request store 112 may also include a list of which load balancer 110 or server 120 has received each request.

Each server 120 may be operable to provide a response to a forwarded request. For example, in various embodiments, a request may be for a web page, a record in a database, a computation related to an online application, or any request for a computational or data service. Such request responses may then be returned to clients 160A-C through network 170.

For the purposes of discussion, load balancers 110 and servers 120 may be said to be “upstream” or “downstream” of each other, depending on where each load balancer 110 or server 120 is in relationship to another load balancer 110 or server 120. For example, as shown in FIG. 1, requests are received at a single load balancer 110 at the top of load balancing hierarchy 100, and relayed to other load balancers 110. Load balancers 110 at a lower level of load balancing hierarchy 100 may be said to be “downstream” of the highest-level load balancer 110. Likewise, any server 120 may be said to be downstream of load balancer hierarchy 100. Conversely, load balancers 110 in load balancer hierarchy 100 may be said to be “upstream” of servers 120.

Both interconnect 150 and network 170 may be a local area network (LAN), a wide area network (WAN), the Internet, system backplane(s), other type of communication medium, or a combination thereof. Load balancers 110 may be operable communicate over interconnect 150 through messages, which may contain request information or control data.

It is noted that many of the details in FIG. 1 are purely illustrative, and that other embodiments are possible. For example, the number of load balancers 110, servers 120, and levels in load-balancer hierarchy 100 is purely illustrative. Load balancer hierarchy 100 may have any number of load balancers 110, servers 120, and levels. In some embodiments, load balancers 100 may be implemented on one or more of the same computers as servers 120.

It is further noted that in one embodiment, communication between load balancers 110 may be between levels in load-balancer hierarchy 100, with each load balancer 110 at every level of load-balancer hierarchy 100 having access to a particular plurality of downstream load balancers 110 or servers 120. However, alternate embodiments may be possible wherein communication is possible between load balancers 110 at the same level of load balancer hierarchy 100, or wherein a plurality of load balancers 110 at one level of load balancer hierarchy 100 may forward requests to one or more common downstream load balancers 110 or servers 120.

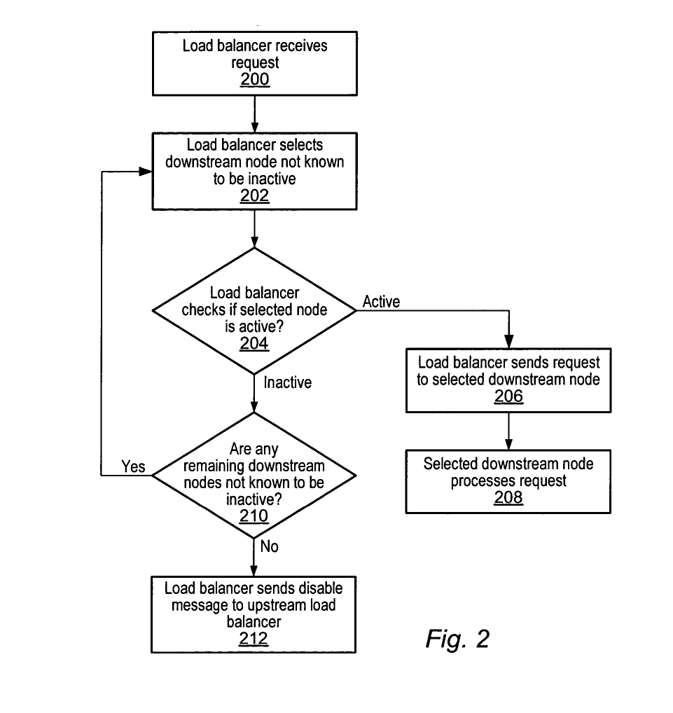

FIG. 2 is a flow diagram illustrating one embodiment of a method for a request failover mechanism in a load-balancing system. In 200, a load balancer 110 in load balancer hierarchy 100 receives a request from an upstream node or client 160A-C.

In 202, the load balancer 110 selects a downstream load balancer 110 or server 120 (hereinafter referred to as a “downstream node” for purposes of discussion) to relay the request to. In various embodiments, the downstream node may be selected by a round-robin scheme, a priority-based scheme, a scheme based on current workload, or a combination of these schemes. The pool of downstream nodes used by the selection scheme may be limited to nodes associated with the load balancer that are not known by the load balancer to be inactive, as will be described in further detail below.

In 204, the load balancer 110 determines if the selected downstream node is active. In various embodiments, the method used to detect the active status of a downstream node may be an active probing method, a passive probing method, or a dummy message method, as will be described further below. Other means to determine the active status of downstream nodes may also be employed. It is noted that methods may return a status indication regarding the selected downstream node. If the selected downstream node is operable to further relay or service a request, then the selected downstream node may be marked as active. If the selected downstream node is non-responsive and thus unable to further relay or service a request, then the selected downstream node may be marked as inactive.

It is noted that in one embodiment, a node marked as inactive may send a message to an upstream load balancer 110 indicating that the inactive node is now operational and ready to receive requests. Upon receiving such a message, the load balancer may change that node's status to active. However, all other messages received from a node marked as inactive may be discarded to avoid corruption or confusion between various request responses.

If the selected downstream node is found to be active in 204, the load balancer 110 advances to 206, where the load balancer forwards the request to the selected downstream node. In 208, the selected downstream node further processes the request, which may entail further load balancing of the request or servicing the request, depending on if the selected downstream node is a load balancer 110 or server 120. In some embodiments, the order of 204 and 206 may be reversed such that the load balancer checks the nodes active status after sending the request to the selected node. In yet other embodiments, the load balancer may determine the active status both before and after sending the request.

If the selected downstream node is found to be inactive in 204, the load balancer 110 advances to 210, wherein the load balancer 110 determines if any downstream nodes associated with the load balancer are not known to be inactive. If there are downstream nodes not known to be inactive, load balancer 110 may then return to 202, wherein another downstream node not known to be currently inactive may be selected.

If, in 210, no downstream nodes remain which are not known to be inactive, the load balancer 110 may advance to 212, wherein the load balancer sends a disable message to its upstream load balancer 110. The purpose of this message is to indicate to the upstream load balancer 110 that the load balancer 110 is no longer able to service requests, since all downstream nodes connected to load balancer 110 are known to be inactive. Load balancer 110 may then cease communication until at least one downstream node becomes active again.

It is noted that in one embodiment, load balancer 110 may cancel all outstanding requests to an inactive downstream node and reassign those requests to other downstream nodes for service. It is further noted that the method described above may be executing on a plurality of load balancers in load balancer hierarchy 100. Therefore, if load balancer 110 reaches step 212 and sends a disable message to an upstream load balancer 110, upstream load balancer 110 may redistribute all requests assigned to the now-inactive load balancer 110 to other load balancers 110 on the same level of load balancer hierarchy 100. Request store 112 may be accessed to determine pending requests to be redistributed.

It is noted that in one embodiment, if load balancer 110 is at the top of load balancer hierarchy 100 and thus is not attached to an upstream load balancer 110, load balancer 110 may continue relaying messages to all downstream nodes, regardless of the inactive status of those nodes.

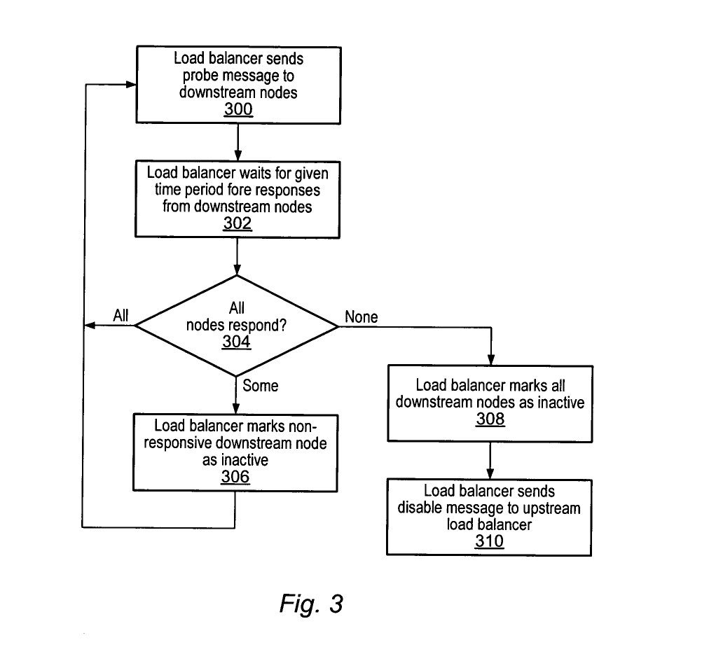

FIG. 3 is a flow diagram illustrating one example of a method for an active probing mechanism for determining the active/inactive status of downstream nodes. In 300, load balancer 110 sends a probe message to all its downstream nodes. This probe message may be limited to a message header and a request that any downstream node receiving the probe message respond to the load balancer 110.

In 302 load balancer 110 waits a predetermined amount of time for all probed downstream nodes to respond. In step 304 the load balancer 110 examines which downstream nodes have responded. If all downstream nodes have responded, the load balancer 110 returns to 300, where it waits an amount of time before beginning the active probing sequence again.

Alternatively, only some downstream nodes may respond to the probe messages sent in 302. In this instance, the load balancer 110 advances to 306, wherein the load balancer 110 marks all downstream nodes which did not respond to the probe messages as offline or inactive. The load balancer 110 may then return to 300, as described above.

The load balancer 110 may also determine in 306 that no downstream nodes have responded to the probe messages. In this scenario, the load balancer 110 advances to 308 and marks all its downstream nodes as inactive, as previously described in 306. The load balancer 110 then advances to 310, wherein the load balancer 110 sends a disable message to its upstream load balancer 110, as described in 212 above.

It is noted that in one embodiment, the active probing method described above in FIG. 3 may be an ongoing background task that periodically or aperiodically evaluates the active status of all nodes downstream of load balancer 110. Accordingly, each time load balancer 110 advances through the method described above in FIG. 2, the information obtained from the active probing mechanism in FIG. 3 may be used to select a downstream node in 202. In an alternate embodiment, the active probing method described above may be activated only when a request needs to be forwarded from a load balancer 110.

In one embodiment, a single node may be responsible for evaluating the active status of all load balancers 110 and servers 120 and providing this information to the load balancers. Alternatively, each load balancer 110 may be responsible for evaluating the active status of its downstream nodes.

In some embodiments, a downstream node may not be marked as inactive until the downstream node has failed to respond to multiple probe messages. In additional embodiments, a load balancer 110 may from time to time attempt to probe a downstream node marked as inactive to determine if the downstream node is now active.

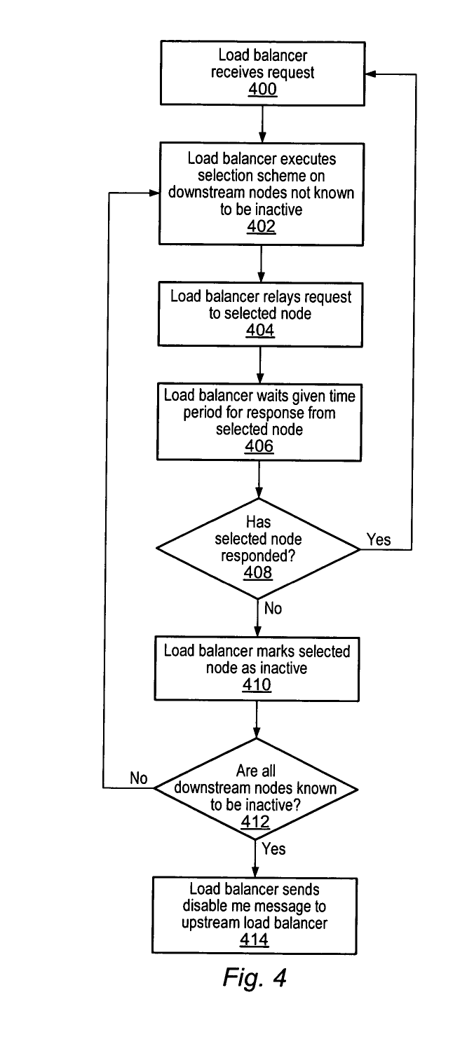

FIG. 4 illustrates another embodiment for request failover using a passive probing mechanism. In 400, a load balancer 110 receives a request from an upstream load balancer 110 or clients 160A-C. In 402 a selection scheme is executed on all downstream nodes not known to be inactive, as described in 202 above.

In 404 load balancer 110 relays the request to the selected downstream node, and monitors the selected downstream node for a response to the request. In 406 load balancer 110 waits a predetermined amount of time for a response from the selected downstream node, then moves to 408. If the selected downstream node has responded to the request, load balancer 110 returns to 400 and receives another request from an upstream load balancer 110 or client 160A-C.

If the selected downstream node has not responded to the request, load balancer 110 moves to 410 and marks the non-responsive downstream node as inactive. The load balancer 110 then moves to 412, wherein it determines if all downstream nodes have been marked as inactive. If all downstream nodes have not been marked as inactive, load balancer 110 returns to 402 and selects another downstream node from the pool of available downstream nodes.

If all downstream nodes have been marked as inactive, load balancer 110 moves to 414 sends a disable message to upstream server 110, as described above in FIG. 2. It is noted that in various embodiments, a downstream node may not be marked as inactive until the downstream node has failed to respond to multiple forwarded requests. In additional embodiments, a load balancer 110 may from time to time forward a request to a downstream node marked as inactive to determine if the downstream node is now active.

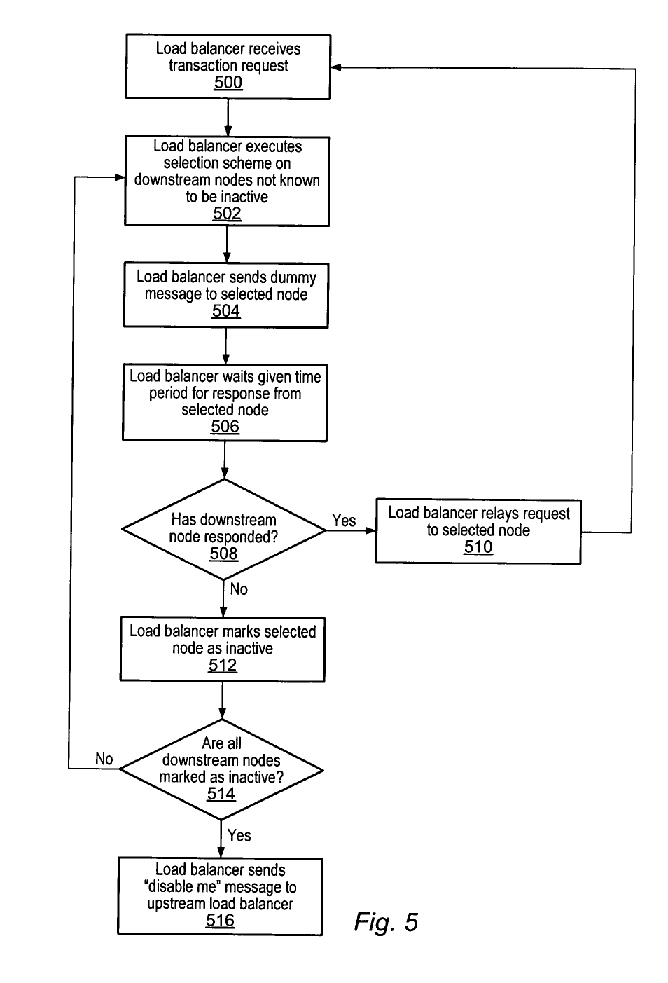

FIG. 5 illustrates yet another example of a method for request failover, this time using a dummy messaging mechanism. In 500, a load balancer 110 receives a request. In 502 load balancer 110 executes a node selection scheme on all downstream nodes not known to be inactive, as described in 202 above.

In 504 load balancer 110 sends a dummy message to the selected downstream node, similar to the probe message sent in 302 in FIG. 3, except the dummy message is sent only to the selected node. In 506 the load balancer 110 waits a predetermined amount of time for a response from the selected downstream node, then moves to 508. If the selected downstream node has responded to the request, the load balancer 110 moves to 510, wherein it forwards the request to the selected downstream node. The load balancer 110 then returns to 500, where it may receive another request.

If the selected downstream node has not responded to the dummy message, the load balancer 110 moves to 512 and marks the non-responsive downstream node as inactive, a mechanism similar to that described in 204 in FIG. 2. The load balancer 110 then advances to 514, wherein it determines if all downstream nodes have been marked as inactive. If all downstream nodes have not been marked as inactive, load balancer 110 returns to 502 and selects another downstream node from the pool of available downstream nodes. If all downstream nodes have been marked as inactive, load balancer 110 moves to 516 and sends a disable message to upstream server 110, as described above.

It is noted that in one embodiment, a downstream node may not be marked as inactive until the downstream node has failed to respond to multiple dummy messages. Likewise, it is noted that in various embodiments, a downstream node may not be marked as inactive until the downstream node has failed to respond to multiple probe messages or forwarded requests, as described in FIGS. 3 and 4, respectively.

FIGS. 3-5 illustrate various techniques for determining the active/inactive status of downstream nodes. Various embodiments of the request failover mechanism in a load-balancing system may employ any one of these techniques, other techniques or a combination of such techniques. For example, a load balancing node may execute a continuous active probing background process for all its downstream nodes and also employ a dummy message and or passive probe for a selected node.

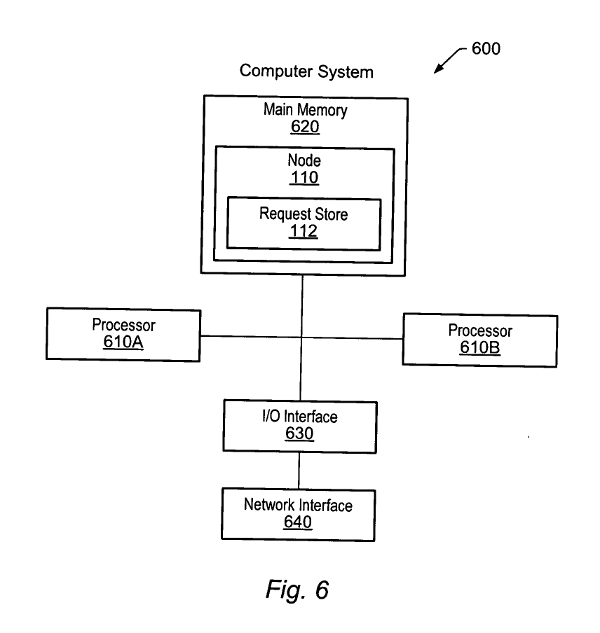

Turning now to FIG. 6, an exemplary computer subsystem 600 is shown. Computer subsystem 600 includes main memory 620, which is coupled to multiple processors 610A-B, and I/O interface 630. It is noted that the number of processors is purely illustrative, and that one or more processors may be resident on the node. I/O interface 630 further connects to network interface 640. Such a system is exemplary of a load balancer, a server in a cluster or any other kind of computing node in a distributed system.

Processors 610A-B may be representative of any of various types of processors such as an x86 processor, a PowerPC processor or a CPU from the SPARC family of RISC processors. Likewise, main memory 620 may be representative of any of various types of memory, including DRAM, SRAM, EDO RAM, DDR SDRAM, Rambus RAM, etc., or a non-volatile memory such as a magnetic media, e.g., a hard drive, or optical storage. It is noted that in other embodiments, main memory 600 may include other types of suitable memory as well, or combinations of the memories mentioned above.

As described in detail above in conjunction with FIGS. 1-5, processors 610A -B of computer subsystem 600 may execute software configured to execute a method for a request failover mechanism in a load-balancing system. The software may be stored in memory 620 of computer subsystem 600 in the form of instructions and/or data that implement the operations described above.

For example, FIG. 6 illustrates an exemplary node 110 stored in main memory 620. The instructions and/or data that comprise a node 110 in any level of load-balancing hierarchy 110 may be executed on one or more of processors 610A-B, thereby implementing the various functionalities of a node 110 described above.

In addition, other components not pictured such as a display, keyboard, mouse, or trackball, for example may be added to computer subsystem 600. These additions would make computer subsystem 600 exemplary of a wide variety of computer systems, such as a laptop, desktop, or workstation, any of which could be used in place of computer subsystem 600.

Various embodiments may further include receiving, sending or storing instructions and/or data that implement the operations described above in conjunction with FIGS. 1-5 upon a computer readable medium. Generally speaking, a computer readable medium may include storage media or memory media such as magnetic or optical media, e.g. disk or CD-ROM, volatile or non-volatile media such as RAM (e.g. SDRAM, DDR SDRAM, RDRAM, SRAM, etc.), ROM, etc. as well as transmission media or signals such as electrical, electromagnetic, or digital signals conveyed via a communication medium such as network and/or a wireless link.

Although the embodiments above have been described in considerable detail, numerous variations and modifications will become apparent to those skilled in the art once the above disclosure is fully appreciated. It is intended that the following claims be interpreted to embrace all such variations and modifications.

1. A method, comprising:
a load balancer receiving a request;
the load balancer selecting a node to handle the request from among a plurality of nodes associated with the load balancer and not known by the load balancer to be inactive;
the load balancer determining if the selected node is able to service the request;
if the selected node is determined to be unable to service the request, the load balancer selecting another node to handle the request from among the plurality of nodes associated with the load balancer and not known by the load balancer to be inactive.

2. The method as recited in claim 1, wherein the load balancer is one load balancer among a plurality of load balancers in a load balancer hierarchy.

3. The method as recited in claim 2, wherein the plurality of nodes associated with the load balancer are load balancers in a lower-level of the load balancer hierarchy.

4. The method as recited in claim 2, wherein the load balancer is associated with a higher-level load balancer in the load balancer hierarchy, and wherein said receiving a request comprises receiving the request from the higher-level load balancer.

5. The method as recited in claim 4, further comprising, if the selected node is determined to be unable to service the request and if no other nodes from among the plurality of nodes associated with the load balancer are not known by the load balancer to be inactive, the load balancer sending a message to the higher-level load balancer to disable the load balancer from receiving further requests.

6. The method as recited in claim 5, further comprising, upon receiving said message, the higher-level load balancer marking the load balancer as inactive.

7. The method as recited in claim 5, further comprising, upon receiving said message, the higher-level load balancer re-load-balancing requests pending with the load balancer among other load balancers associated with the higher-level load balancer.

8. The method as recited in claim 1, wherein said determining if the selected node is able to service the request comprises the load balancer actively probing the plurality of nodes associated with the load balancer.

9. The method as recited in claim 8, further comprising the load balancer periodically performing said actively probing.

10. The method as recited in claim 8, further comprising, if one of the plurality of nodes associated with the load balancer does not respond to said active probing within a timeout period, the load balancer marking that node as inactive.

11. The method as recited in claim 10, wherein the load balancer marking that node as inactive comprises re-load-balancing requests pending with that node among the plurality of nodes associated with the load balancer and not known by the load balancer to be inactive.

12. The method as recited in claim 10, wherein the load balancer marking that node as inactive comprises, if no other nodes from among the plurality of nodes associated with the load balancer are not known by the load balancer to be inactive, the load balancer sending a message to the higher-level load balancer to disable the load balancer from receiving further requests.

13. The method as recited in claim 1, further comprising:
the load balancer sending the request to the selected node;
wherein said determining if the selected node is able to service the request comprises the load balancer determining if the selected node fails to respond to the request within a timeout period.

14. The method as recited in claim 13, further comprising, if the selected node fails to respond to the request within the timeout period, the load balancer marking the selected node as inactive.

15. The method as recited in claim 14, wherein the load balancer marking the selected node as inactive comprises, if no other nodes from among the plurality of nodes associated with the load balancer are not known by the load balancer to be inactive, the load balancer sending a message to the higher-level load balancer to disable the load balancer from receiving further requests.

16. The method as recited in claim 14, wherein the load balancer marking the selected node as inactive comprises re-load-balancing requests pending with the selected node among the plurality of nodes associated with the load balancer and not known by the load balancer to be inactive.

17. The method as recited in claim 1, further comprising:
after said selecting the node, the load balancer sending a dummy request to the selected node;
wherein said determining if the selected node is able to service the request comprises the load balancer determining if the selected node fails to respond to the dummy request within a timeout period.

18. The method as recited in claim 17, further comprising if the selected node fails to respond to the dummy request within the timeout period, the load balancer marking the selected node as inactive.

19. The method as recited in claim 18, wherein the load balancer marking the selected node as inactive comprises, if no other nodes from among the plurality of nodes associated with the load balancer are not known by the load balancer to be inactive, the load balancer sending a message to the higher-level load balancer to disable the load balancer from receiving further requests.

20. The method as recited in claim 18, wherein the load balancer marking the selected node as inactive comprises re-load-balancing requests pending with the selected node among the plurality of nodes associated with the load balancer and not known by the load balancer to be inactive.

21. The method as recited in claim 17, further comprising, if the selected node responds to the dummy request within the timeout period, the load balancer sending the request to the selected node.

22. The method as recited in claim 21, wherein said determining if the selected node is able to service the request further comprises the load balancer determining if the selected node fails to respond to the request within a timeout period.

23. The method as recited in claim 1, wherein said determining if the selected node is able to service the request comprises the load balancer receiving a message from the selected node indicating that the selected node is disabled.

24. The method as recited in claim 23, further comprising, upon receiving said message, the load balancer marking the selected node as inactive.

25. The method as recited in claim 24, further comprising, upon receiving said message, the load balancer re-load-balancing requests pending with the selected node among the plurality of nodes associated with the load balancer and not known by the load balancer to be inactive.

26. A system, comprising:
a plurality of nodes;
a load balancer associated with said plurality of nodes, wherein the load balancer is configured to:
receive a request;
select a node to handle the request from the plurality of nodes, wherein the plurality of nodes are not known by the load balancer to be inactive;
determine if the selected node is able to service the request;
select another node to handle the request from among the plurality of nodes not known by the load balancer to be inactive if the selected node is determined to be unable to service the request.

27. The system of claim 26 further comprising a load balancer hierarchy, wherein the load balancer is one load balancer among a plurality of load balancers in the load balancer hierarchy.

28. The system of claim 27, wherein the plurality of nodes are load balancers in a lower-level of the load balancer hierarchy.

29. The system of claim 27, wherein the load balancer is associated with a higher-level load balancer in the load balancer hierarchy, and wherein the load balancer is configured to receive the request from the higher-level load balancer.

30. The system of claim 29 wherein the load balancer is further configured to send a message to the higher-level load balancer to disable the load balancer from receiving further requests if the selected node is determined to be unable to service the request and if no other nodes from among the plurality of nodes associated with the load balancer are not known by the load balancer to be inactive.

31. The system of claim 30 wherein the higher-level load balancer is configured to mark the load balancer as inactive upon receiving said message.

32. The system of claim 30 wherein the higher-level load balancer is configured to re-load-balance requests pending with the load balancer among other load balancers associated with the higher-level load balancer upon receiving said message.

33. The system of claim 26, wherein to determine if the selected node is able to service the request, the load balancer is configured to actively probe the plurality of nodes associated with the load balancer.

34. The system of claim 33, wherein the load balancer is configured to periodically actively probe the plurality of nodes associated with the load balancer.

35. The system of claim 33 wherein the load balancer is configured to mark one of the plurality of nodes associated with the load balancer as inactive if that node does not respond to the active probe within a timeout period.

36. The system of claim 35, wherein the load balancer is configured to re-load-balance requests pending with the inactive node among the plurality of nodes associated with the load balancer and not known by the load balancer to be inactive.

37. The system of claim 35, wherein, if no other nodes from among the plurality of nodes associated with the load balancer are not known by the load balancer to be inactive, the load balancer is configured to send a message to the higher-level load balancer to disable the load balancer from receiving further requests.

38. The system of claim 26 wherein the load balancer is further configured to send the request to the selected node; and to determine if the selected node is able to service the request, the load balancer is configured to determine if the selected node fails to respond to the request within a timeout period.

39. The system of claim 38 wherein the load balancer is configured to mark the selected node as inactive if the selected node fails to respond to the request within the timeout period.

40. The system of claim 39, wherein, if no other nodes from among the plurality of nodes associated with the load balancer are not known by the load balancer to be inactive, the load balancer is configured to send a message to the higher-level load balancer to disable the load balancer from receiving further requests.

41. The system of claim 39, wherein the load balancer is configured to re-load-balancing requests pending with the inactive node among the plurality of nodes associated with the load balancer and not known by the load balancer to be inactive.

42. The system of claim 26 wherein the load balancer is configured to send a dummy request to the selected node after selecting the node, and wherein to determine if the selected node is able to service the request, the load balancer is configured to determine if the selected node fails to respond to the dummy request within a timeout period.

43. The system of claim 42 wherein the load balancer is configured to mark the selected node as inactive if the selected node fails to respond to the dummy request within the timeout period.

44. The system of claim 43, wherein, if no other nodes from among the plurality of nodes associated with the load balancer are not known by the load balancer to be inactive, the load balancer is configure to send a message to the higher-level load balancer to disable the load balancer from receiving further requests.

45. The system of claim 43, wherein the load balancer is configure to re-load-balance requests pending with the inactive node among the plurality of nodes associated with the load balancer and not known by the load balancer to be inactive.

46. The system of claim 42 wherein the load balancer is configured to send the request to the selected node if the selected node responds to the dummy request within the timeout period.

47. The system of claim 46, wherein to determine if the selected node is able to service the request, the load balancer is further configured to determine if the selected node fails to respond to the request within a timeout period.

48. The system of claim 26, wherein to determine if the selected node is able to service the request, the load balancer is configured to receive a message from the selected node indicating that the selected node is disabled.

49. The system of claim 48 wherein the load balancer is configured to mark the selected node as inactive upon receiving said message.

50. The system of claim 49 wherein the load balancer is configured to re-load-balance requests pending with the selected node among the plurality of nodes associated with the load balancer and not known by the load balancer to be inactive upon receiving said message.

51. A computer accessible medium, comprising program instructions executable to implement:
a load balancer receiving a request;
the load balancer selecting a node to handle the request from among a plurality of nodes associated with the load balancer and not known by the load balancer to be inactive;
the load balancer determining if the selected node is able to service the request;
if the selected node is determined to be unable to service the request, the load balancer selecting another node to handle the request from among the plurality of nodes associated with the load balancer and not known by the load balancer to be inactive.
